(19) United States
(12) Patent Application Publication
(10) Pub. No.: US 2008/0249982 A1
(43) Pub. Date: Oct. 9, 2008

(54) Audio search system

(75) Inventor: Seth Lakowske, Madison, WI (US)

Correspondence Address: Casimir Jones, S.C., 440 Science Drive, Suite 203, Madison, WI, 53711, US

(73) Assignee: Ohigo, Inc., Fitchburg, WI (US)

(21) Appl. No.: 11/591,322

(22) Filed: Nov. 1, 2006

Related U.S. Application Data
(60) Provisional application No. 60/732,026, filed on Nov. 1, 2005.

(51) Int. Cl. G06F 17/30; G09B 15/02

(52) U.S. Cl. 707/3; 707/100; 84/477 R; 707/E17.101

(57) ABSTRACT

The present invention relates to systems and methods for identifying audio files. In particular, the present invention relates to systems and methods for identifying audio files (e.g., music files) with user-established search criteria. The systems and methods of the present invention allow a user to use an audio file to search for audio files having similar audio characteristics. The audio characteristics are identified by an automated system using statistical comparison of audio files. The searches are preferably based on audio characteristics inherent in the audio file submitted by the user.

This application claims the benefit of U.S. Prov. Appl. No. 60/732,026 filed Nov. 1, 2005, which is incorporated by reference herein in its entirety.

### FIELD OF THE INVENTION

The present invention relates to systems and methods for identifying audio files. In particular, the present invention relates to systems and methods for identifying audio files (e.g., music files) with user-established search criteria.

### BACKGROUND

Identifying music that appeals to an individual is a complex task. With many online locations providing access to music, the ability to discern what types of music a person likes and dislikes is nearly impossible. Various internet based search engines exist which provide an ability to identify music based upon textual queries. However, such searches are limited to a particular title for a piece of music or the entity that performed the musical piece. What are needed are improved systems and methods for identifying music and audio files. Additionally, what are needed are improved software which provides an ability to identify music based upon user-established criteria.

### SUMMARY OF THE INVENTION

The present invention relates to systems and methods for identifying audio files. In particular, the present invention relates to systems and methods for identifying audio files (e.g., music files) with user-established search criteria.

In certain embodiments, the present invention provides a system for identifying audio files using a search query comprising a processing unit and a digital memory comprising a database of greater than 1,000 audio files, wherein search queries from the processor to the database are returned in less than about 10 seconds. In preferred embodiments, the database of audio files is a relational database. In preferred embodiments, the relational database is searchable by comparison to audio files with multiple criteria. In preferred embodiments, the multiple criteria are selected from the group consisting of genre, rhythm, tempo and frequency combinations and combinations thereof. In other preferred embodiments, the audio files are more than 1 minute in length. In yet other preferred embodiments, the audio files are selected from the group consisting of songs, speeches, musical pieces, sound effects and combination thereof.

In preferred embodiments, the system further comprises an input device. In preferred embodiments, the audio file is designated as owned by a user or not owned by a user.

In certain embodiments, the present invention provides a system comprising a processing unit and a digital memory comprising a database of audio files searchable by comparison to audio files with multiple criteria. In preferred embodiments, the multiple criteria are selected from the group consisting of genre, rhythm, tempo and frequency combinations and combinations thereof. In other preferred embodiments, the audio files are more than 1 minute in length. In yet other preferred embodiments, the audio files are designated as owned by a user or not owned by a user.

In preferred embodiments, the audio files are selected from the group consisting of songs, speeches, musical pieces, sound effects and combination thereof. In other preferred embodiments, the system further comprises an input device.

In certain embodiments, the present invention provides a method of searching a database of audio files comprising providing a digitized database of audio files tagged with multiple criteria, querying the database with an audio file comprising at least one desired criteria so that audio files matching the criteria are identified. In preferred embodiments, the query is answered in less than about 10 seconds. In other preferred embodiments, the database is a relational database. In yet other preferred embodiments, the audio files are more than 1 minute in length.

In preferred embodiments, the audio files are selected from the group consisting of songs, speeches, musical pieces, sound effects and combination thereof. In other preferred embodiments, the audio files are designated as owned by a user or not owned by a user.

In certain embodiments, the present invention provides a digital database comprising audio files searchable by comparison to audio files with multiple criteria. In preferred embodiments, the multiple criteria are selected from the group consisting of genre, rhythm, tempo and frequency combinations and combinations thereof. In preferred embodiments, the audio files are more than 1 minute in length. In other preferred embodiments, the audio files are selected from the group consisting of songs, speeches, musical pieces, sound effects and combination thereof. In yet other preferred embodiments, the audio files are designated as owned by a user or not owned by a user

In certain embodiments, the present invention provides a method of classifying audio files for electronic searching comprising providing a plurality of audio files; classifying the audio files with a plurality of criteria to provide classified audio files; storing the classified audio files in a database; adding additional audio files to the database, wherein the additional audio files are automatically classified with the plurality of criteria. In preferred embodiments, the multiple criteria are selected from the group consisting of genre, rhythm, tempo and frequency combinations and combinations thereof. In other preferred embodiments, the audio files are more than 1 minute in length. In yet other preferred embodiments, the audio files are selected from the group consisting of songs, speeches, musical pieces, sound effects and combination thereof.

In further embodiments, the present invention provides methods of providing a user with a personalized radio program comprising: a) providing a digitized database of database sound files associated with multiple audio characteristics; b) allowing a user to query said database with a query sound file so that database files are identified that match said query sound files; and c) transmitting said audio files to said user.

In further embodiments, the present invention provides methods of providing advertising keyed to sound criteria comprising: a) providing a digitized database of database sound files associated with multiple audio characteristics; b) allowing a user to query said database with a query sound file so that database files are identified that match said query sound files; and c) on the basis of said sound criteria, providing advertising to said user.

In further embodiments, the present invention provides methods of advertising purchasable audio files comprising: a) providing a digitized database of database sound files associated with multiple audio characteristics; b) allowing a user to query said database with a query sound file so that database files are identified that match said query sound files; c) on the basis of said sound criteria, identifying audio files; d) offering said audio files to said user for purchase.

In further embodiments, the present invention provides methods for selecting a sequence of songs to be played comprising: a) providing a digitized database of database sound files associated with multiple audio characteristics; b) allowing a user to query said database with a query sound file so that database files are identified that match said query sound files; and c) playing said audio files based on said criteria.

In further embodiments, the present invention provides methods of identifying an audio file comprising: a) providing an audio file; b) associating said audio file with at least three common audio characteristics to create a sound thumbnail.

In further embodiments, the present invention provides methods of identifying movies by sound criteria comprising: a) providing a digitized database of database sound files associated with multiple audio characteristics; b) allowing a user to query said database with a query sound file so that database files are identified that match said query sound files; and c) selecting at least one movie with matching sound criteria.

In further embodiments, the present invention provides methods of characterizing movies by sound criteria comprising: a) providing a digitized database of movie audio files associated with multiple audio characteristics; b) categorizing said movie audio files according to said criteria.

In further embodiments, the present invention provides methods of scoring karaoke performances comprising: a) providing a digitized database of audio files associated with multiple audio characteristics; b) querying said database with live performance audio; c)comparing said digitized audio files with said live performance audio according to preset criteria.

In further embodiments, the present invention provides methods of creating a list of digitized audio files comprising: a) providing a digitized database of database sound files associated with multiple audio characteristics; b) allowing a user to query said database with a query sound file so that database files are identified that match said query sound files; and c) generating a subset of audio files identified by said user-defined criteria.

In further embodiments, the present invention provides methods associating musical preferences with a user comprising: a) providing a digitized database of database sound files associated with multiple audio characteristics; b) allowing a user to query said database with a query sound file so that database files are identified that match said query sound files; and c) associating preferred criteria with said user.

In further embodiments, the present invention provides methods of identifying desirable audio files comprising: a) providing a digitized database of database sound files tagged associated with multiple audio characteristics; b) allowing a user to query said database with a query sound file so that database files are identified that match said query sound files; and c) categorizing audio files according to the to the results of multiple user queries.

In further embodiments, the present invention provides methods of associating users with similar musical preferences comprising: a) providing a digitized database of database sound files associated with multiple audio characteristics; b) allowing a user to query said database with a query sound file so that database files are identified that match said query sound files; c) associating preferred audio characteristics with said user; d) using said preferred criteria to associate groups of users.

### BRIEF DESCRIPTION OF THE DRAWINGS

FIG. 1 shows a schematic presentation of an audio search system embodiment of the present invention.

FIG. 2 shows an embodiment of a query engine comprising a tag relational database and a query engine search application.

FIG. 3 shows an embodiment of a digital memory comprising a global tag database and a digital memory search application.

FIG. 4 shows a schematic presentation of the steps involved in the development of a tag relational database within the audio search system.

FIG. 5 shows a schematic presentation of the steps involved in an audio search request performed with the audio search system.

FIG. 6 shows a schematic presentation of the steps involved in an audio search request performed with the audio search system.

FIG. 7 is a block schematic diagram describing how databases of the present invention are constructed.

FIG. 8 is a block schematic diagram demonstrating how the music database is queried.

### DEFINITIONS

To facilitate an understanding of the present invention, a number of terms and phrases are defined below.

As used herein, the terms “audio file” or “sound file” refer to any type of digital file containing sound data such as music, speech, other sounds, and combinations thereof. Examples of audio file formats include, but are not limited to, PCM (Pulse Code Modulation, generally stored as a .wav (Windows) or .aiff (Mac-OS) file), Broadcast Wave Format (BWF, Broadcast Wave File), TTA (True Audio), FLAC (Free Lossless Audio Codec), MP3 (which uses the MPEG-1 audio layer 3 codec), Windows Media Audio, Vorbis, Advanced Audio Coding (AAC, used by iTunes), Dolby Digital (AC-3) or midi file. A “query sound file” is a sound file selected by a user as input for a search. A “database sound file” is a sound file stored on a database.

As used herein, the term “audio segment” refers to a portion of an “audio file.” A portion of the audio file is defined by, for example, a starting position and an ending position. An example of an audio segment is an MP3 file starting at 15 seconds and ending at 23 seconds. Such a definition refers to seconds 15 to 23 of the “audio file.”

As used herein, the term “audio characteristic” refers to a distinguishable feature of an “audio segment.” Examples of audio characteristics include, but are not limited to, genre (e.g., rock-n-roll, blues, classical, pop, dance, country, jazz), rhythm (e.g., fast, moderate, slow), tempo (e.g., grave, largo, lento, larghetto, adagio, andante, andantino, allegretto, allegro, vivace, presto, prestissimo, moderato, molto, accelerando, ritardando), pitch (e.g., high tone, low tone), instrument (e.g., guitar, drums, violin, piano, flute), key (e.g., A, A#, B, C, C#, D, D#, E, F, F#, G, G#), beat (e.g., 1 beat per measure, 2 beats per measure), performer, date of performance, title, happy, sad, mad, moody, angry, depressed, manic, elated, dejected, traumatic, curious, etc.

As used herein, the term “audio criteria” refers to one or more “audio tag(s).” The “audio criteria” are typically used, for example, to constrain audio searches.

As used herein, the terms “processor” and “central processing unit” or “CPU” are used interchangeably and refers to a device that is able to read a program from a computer memory (e.g., ROM or other computer memory) and perform a set of steps according to the program.

As used herein, the term “digital memory” refers to any storage media readable by a computer processor. Examples of computer memory include, but are not limited to, RAM, ROM, computer chips, digital video disc (DVDs), compact discs (CDs), hard disk drives (HDD), and magnetic tape.

The term relational database refers to a collection of data, wherein the data comprises a collection of tables related to each other through common values. A table (i.e., an entity or relation) is a collection of rows and columns. A row (i.e., a record or tuple) represents a collection of information about a separate item (e.g., a customer). A column (i.e., a field or attribute) represents the characteristics of an item (e.g., the customer's name or phone number). A relationship is a logical link between two tables. A relational database management system (RDBMS) uses matching values in multiple tables to relate the information in one table with the information in the other table. The presentation of data as tables is a logical construct; it is independent of the way the data is physically stored on disk.

As used herein, the term “tag” refers to an identifier that can be associated with an audio file that corresponds to an audio characteristic of the audio file. Examples of tags include, but are not limited to, identifiers corresponding to audio characteristics such as tempo, classical music, happy, key, title, and guitar. In preferred embodiments, “tags” are entered into the rows of a relational database and relate to particular audio files.

As used herein, the term “client-server” refers to a model of interaction in a distributed system in which a program at one site sends a request to a program at another site and waits for a response. The requesting program is called the “client,” and the program which responds to the request is called the “server.” In the context of the World Wide Web (discussed below), the client is a “Web browser” (or simply “browser”) which runs on a computer of a user; the program which responds to browser requests by serving Web pages is commonly referred to as a “Web server.”

### DETAILED DESCRIPTION

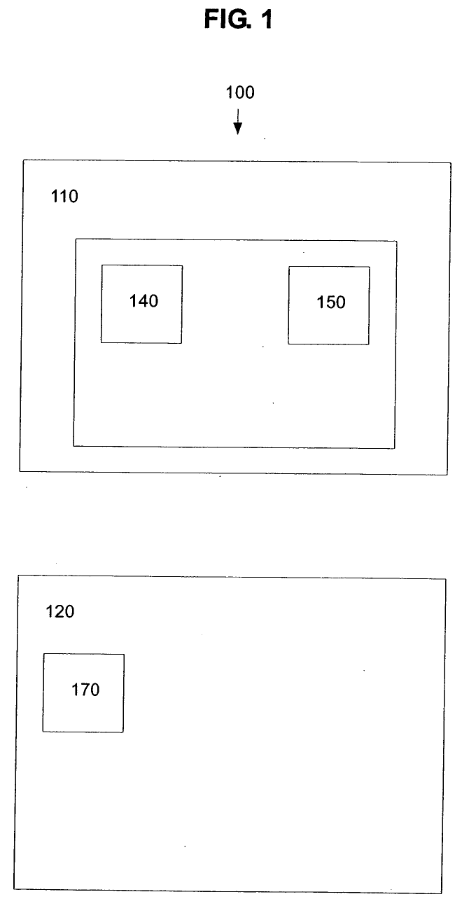

The present invention relates to systems and methods for identifying audio files. In particular, the present invention relates to systems and methods for identifying audio files (e.g., music files, speech files, sound files, and combinations thereof) with user-established search criteria. FIGS. 1-8 illustrate various preferred embodiments of the audio search systems of the present invention. The present invention is not limited to these particular embodiments. The systems and methods of the present invention allow a user to use an audio file to search for audio files having similar audio characteristics. The audio characteristics are identified by an automated system using statistical comparison of audio files. The searches are preferably based on audio characteristics inherent in the audio file submitted by the user.

The audio search systems and methods of the present invention are applicable for identifying audio files (e.g., music) based upon common audio characteristics. The audio search systems of the present invention permit a user to search a database of audio files that are associated or tagged with one or more audio characteristics, and identify different types of audio files with similar audio characteristics.

The audio search systems of the present invention have numerous advantages over prior art audio identification systems. For example, the audio search systems of the present invention are not limited to identifying audio files through textually based queries. Instead, the user may input an audio file and search for matching audio files. Queries with the audio search systems of the present invention are not limited to searching short sound effects but rather all types of audio files can be searched (e.g., speech files, music files, sound files, and combinations thereof). Additionally, queries with the audio search systems of the present invention are based upon multiple criteria associated with audio file characteristics (e.g., genre, rhythm, tempo, frequency combination). These audio characteristics may be user-defined or generated by a statistical analysis of a digitized audio file. Queries with the audio search systems of the present invention are capable of matches to entire audio files as well as portions (e.g., less than 100% of an audio file) of an audio file. Additionally, queries with the audio search systems of the present invention are performed at very fast speeds as the queries only involve the detection of pre-established criterion flags assigned to a database of audio files. The present invention is not limited to any particular mechanism. Indeed, an understanding of the mechanism is not necessary to practice the present invention. Nevertheless, it is contemplated that the audio search systems and methods of the present invention function on the principle that audio files sharing similar audio characteristics (e.g., genre, tempo, beat, key) can be identified with software designed to establish audio characteristics for the purpose of identifying audio files sharing common audio characteristics (described in more detail below).

In other embodiments, the process of creating audio characteristic tags for audio files is automated. In these embodiments, an audio characteristic, which can be any perceptually unique or repeated audio characteristic, is designated a tag and associated with an audio file by a statistical algorithm. The decision process can be accomplished using a decision tree or a clustering method.

In the decision tree method, large collections of pre-tagged sound segments are examined to determine which audio characteristics (which can be statistically determined by an analysis of frequency) are the best indicators of a tag. Once these indicators are found they are encoded in logical rules and are used to examine audio which is not pre-tagged.

In the clustering method, large collections of sound segments are examined to determine which frequency combinations occur most frequently. Once these frequency combinations are found they are encoded in logical rules and labeled with a tag (e.g., a serial number). The logical rules are used to examine audio that is not tagged. The clustering method then tags the audio based on which frequency combination it is most near.

In some embodiments, multiple sound qualities are joined in sequence and form a sound clip. In further embodiments, basis sound clips are developed that contain fundamental sound qualities such as a major or minor scales, chords and percussion elements. In some embodiments, a database is generated using basis sound clips to initiate the formation of the database. As additional songs are added to the database, they are grouped based on the audio characteristics found in the initial basis sound clips. In some embodiments, the basis sound clips are generated from midi files, which are similar to a piano rolls (player piano song descriptions). By recording the playback of midi files with different profiles (i.e. voices, piano, guitar, trumpet, etc.), many different basis sound clips can be generated. Audio characteristics within the sound clips are compared to audio characteristics in songs added to the database and the songs are tagged as containing specific sound qualities. Users can then search the database by inputting audio files containing preferred audio characteristics. The audio characteristics in the input audio file are compared with audio characteristics of audio files in the database via tags associated with audio files in the database to identify sound clips or sound files containing similar sound qualities. Audio files containing similar audio characteristics are then ranked and identified in a search report.

In further embodiments, a sound thumbnail is created by associating an audio file with at least three common audio characteristics contained within the audio file. The sound thumbnails can then be used to search a database, or, in the alternative, serve as tags for an audio file. In some embodiments, a database containing a subset of audio files identified by a sound thumbnail or sound thumbnails is created.

FIG. 1 shows a schematic presentation of an audio search system embodiment of the present invention. Referring to FIG. 1, the audio search system 100 generally comprises a processor 110 and a digital memory 120. In preferred embodiments, the audio search system 100 is configured to identify audio files (e.g., songs) sharing similar audio characteristics with audio files input by a user (described in more detail below).

Still referring to FIG. 1, the present invention is not limited to a particular type of processor 110 (e.g., a computer). In preferred embodiments, the processor 110 is configured to interface with an internet based database for purposes of identifying audio files (described in more detail below). In preferred embodiments, the processor 110 is configured such that it can flag an audio file for purposes of identifying similar audio files in a database (described in more detail below).

Still referring to FIG. 1, in preferred embodiments, the processor 110 comprises a query engine 130. The present invention is not limited to a particular type of query engine 130. In preferred embodiments, the query engine 130 is a software application operating from a computer. In preferred embodiments, the query engine 130 is configured to receive an inputted audio file, assign user-established labels (e.g., tags) to the received inputted audio file, generate a relational database compiling the user-established labels, generate audio file search requests containing criteria based in the user-established labels, transmit the audio file search requests to an external database capable of identifying audio files, and obtain (e.g., download) audio files from an external database (described in more detail below).

Still referring to FIG. 1, the query engine 130 is not limited to receiving an audio file in a particular format (e.g., wav, shn, flac, mp3, aiff, ape). The query engine 130 is not limited to a particular duration of an audio file (e.g., 1 second, 10 seconds, 1 minute, 1 hour). The query engine 130 is not limited to a particular type of an audio file (e.g., music file, speech file, sound file, or combination thereof). The query engine 130 is not limited to a particular manner of receiving an inputted audio file. In preferred embodiments, the query engine 130 receives an audio file from a computer. In other embodiments, the query engine 130 receives an audio file from an external source (e.g., an internet based database, a compact disc, a DVD). In preferred embodiments, the query engine 130 is configured to receive an audio file for purposes of labeling or associating the audio file with tags corresponding to audio characteristics (described in more detail below).

Still referring to FIG. 1, the query engine 130 comprises a tagging application 140. In preferred embodiments, the tagging application 140 is configured to associate an audio file with at least one tag corresponding to an audio characteristic. The tagging application 140 is not limited to particular label tags. For example, tags useful in labeling an audio file include, but are not limited to, tags corresponding to one or more of the following audio characteristics: genre (e.g., rock-n-roll, blues, classical, pop, dance, country, jazz), rhythm (e.g., fast, moderate, slow), tempo (e.g., grave, largo, lento, larghetto, adagio, andante, andantino, allegretto, allegro, vivace, presto, prestissimo, moderato, molto, accelerando, ritardando), pitch (e.g., high tone, low tone), instrument (e.g., guitar, drums, violin, piano, flute), key (e.g., A, A#, B, C, C#, D, D#, E, F, F#, G, G#), beat (e.g., 1 beat per measure, 2 beats per measure), performer, date of performance, title, happy, sad, mad, moody, angry, depressed, manic, elated, dejected, traumatic, curious, etc. The tagging application 140 is not limited to a particular manner of associating an audio file with a tag. In some embodiments, an entire audio file may be associated with a tag. In other embodiments, only a subsection (e.g., portion) of an audio file may be associated with a tag. In preferred embodiments, there is no limit to the number of tags that may be assigned to a particular audio file. In preferred embodiments, upon assignment of a tag to an audio file, the tagging application 140 is configured to associate the audio characteristics of the audio file (e.g., tempo, key, instruments) with the assigned tag such that the tag assumes a definition associated with such characteristics. In preferred embodiments, the tags associated with an audio file (which correspond to audio characteristics) are used to identify audio files with similar characteristics (described in more detail below).

Still referring to FIG. 1, in some embodiments, the query engine 130 is configured to generate a tag relational database 150. In preferred embodiments, the tag relational database 150 provides consensus definitions of tags based upon statistical compilation of the characteristics of inputted audio files associated with a particular tag. In preferred embodiments, the tag relational database 150 provides confidence values for a particular tag (e.g., for “tag X” a 90% likelihood of a 4/4 beat structure, a 95% likelihood of an electric guitar, an 80% likelihood of a female voice, and a 10% likelihood of a trumpet). In preferred embodiments, the tag relational database 150 is configured to combine at least two tag values so as to generate new tag values (e.g., combine “tag A” with “tag B” to create “tag X,” such that the characteristics of “tag A” and “tag B” are combined into “tag X”). In preferred embodiments, the tag relational database 150 is configured to interact with a digital memory 120 for purposes of identifying audio files (described in more detail below).

Still referring to FIG. 1, the query engine 130 is configured to assemble an audio file search request for purposes of identifying audio files. The query engine 130 is not limited to a particular method of generating an audio file search request. In preferred embodiments, an audio file search request is generated through selecting various tags (e.g., rock-n-roll, 4/4 beat, key of G#, saxophone) for a desired type of audio from the tag relational database 150. In still more preferred embodiments, the audio file search request comprises an audio file input by a user. In preferred embodiments, the audio file search request further represents the audio characteristics associated with each tag (as described above). In preferred embodiments, the audio characteristics are of the input audio file are determined by statistical analysis by a computer algorithm (described in more detail below). The audio file search request is not limited to a particular number of tags selected from the tag relational database. In preferred embodiments, the audio file search request is used to identify audio files within an external database (described in more detail below).

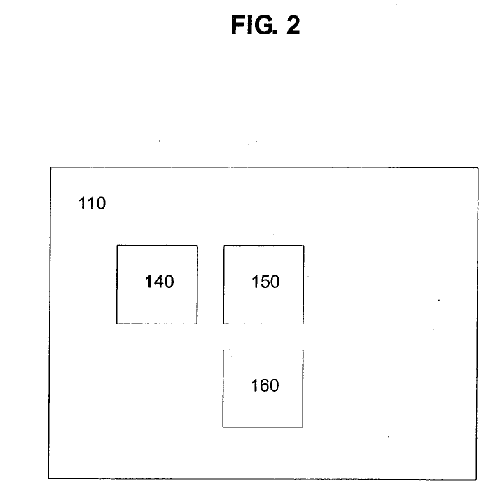

FIG. 2 shows an embodiment of a query engine 130 comprising a tag relational database 150 and a query engine search application 160. In preferred embodiments, the query engine search application 160 is configured to generate audio file search requests. In preferred embodiments, the query engine search application 160 generates an audio file search request by identifying various audio characteristics corresponding to tags (e.g., rock-n-roll, 4/4 beat, key of G#, saxophone) within the audio file to be used to search the tag relational database 150.

Referring again to FIG. 1, the query engine 130 is configured to transmit the audio file search request to an external database. The query engine 130 is not limited to a particular method of transmitting the audio file search request. In preferred embodiments, the query engine 130 transmits the audio file search request via the internet.

Still referring to FIG. 1, the audio search systems 100 of the present invention are not limited to a particular type of external database. In preferred embodiments, the external database is a digital memory 120. In preferred embodiments, the digital memory 120 is configured to store audio files and information pertaining to audio files. The present invention is not limited to a particular type of digital memory 120. In some embodiments, the digital memory 120 is a server-based database. In preferred embodiments, the digital memory 120 is an internet based server. The digital memory 120 is not limited to a particular storage capacity. In preferred embodiments, the storage capacity of the digital memory 120 is at least one terabyte. The digital memory 120 is not limited to storing audio files in a particular format (e.g., wav, shn, flac, mp3, aiff, ape). The digital memory 120 is not limited to a particular source of an audio file (e.g., music file, speech file, sound file, and combination thereof). In preferred embodiments, the digital memory 120 is configured to interact with the query engine 110 for purposes of identifying audio files (described in more detail below).

Still referring to FIG. 1, in preferred embodiments, the digital memory 120 has therein a global tag database 170 for categorically storing audio files. In preferred embodiments, the global tag database 170 is configured to analyze an audio file, identify the audio characteristics of the audio file (e.g., tone, tempo, instruments used, name of musical piece, etc), assign global tags to the audio file based upon the identified audio characteristics, and categorize large groups (e.g., over 10,000) of audio files based upon the assigned global tags. The global tag database 170 is not limited to the use of particular global tags. In preferred embodiments, the global tag database 170 uses global tags that are consistent with the characteristics of the audio file (e.g., tone, tempo, instruments used, name of musical piece, etc.). In preferred embodiments, the global tag database 170 configured to interact with the tag relational database 150 for purposes of identifying audio files (described in more detail below).

Still referring to FIG. 1, the digital memory 130 is configured receive audio search requests transmitted from a query engine 110. In preferred embodiments, the digital memory 130 is configured to identify audio files based upon the criteria provided in the audio file search request. In preferred embodiments, the global tag database 150 is configured to identify audio files with global tags consistent with the musical characteristics associated with the tags presented in the audio search request. The digital memory 130 is configured to generate an audio search request report detailing the results of the audio search. The global tag database 150 is not limited to a particular speed for performing an audio file search request. In preferred embodiments, the global tag database 150 is configured to perform an audio file search request in less than 1 minute. In preferred embodiments, the audio search request report is transmitted to the processor 110 via an internet based message. In preferred embodiments, the audio search request report provides information regarding the audio search including, but not limited to, audio file names and audio file title. In preferred embodiments, the processor 110 is configured to download audio files identified through the audio file search request from the digital memory 120.

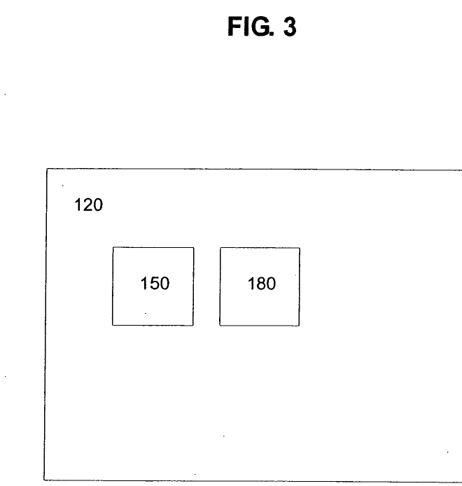

FIG. 3 shows an embodiment of a digital memory 120 comprising a global tag database 150 and a digital memory search application 180. In preferred embodiments, the digital memory search application 180 is configured to identify audio files based upon the criteria provided in the audio file search request, which in preferred embodiments can be an audio file input by a user. In preferred embodiments, the global tag database 150 is configured to identify audio files with global tags consistent with the audio characteristics associated with the tags generated for the input audio file. The digital memory search application 180 is configured to generate an audio search request report detailing the results of the audio search. The digital memory search application 180 is not limited to a particular speed for performing an audio file search request. In preferred embodiments, the digital memory search application 180 is configured to perform an audio file search request in less than 1 minute.

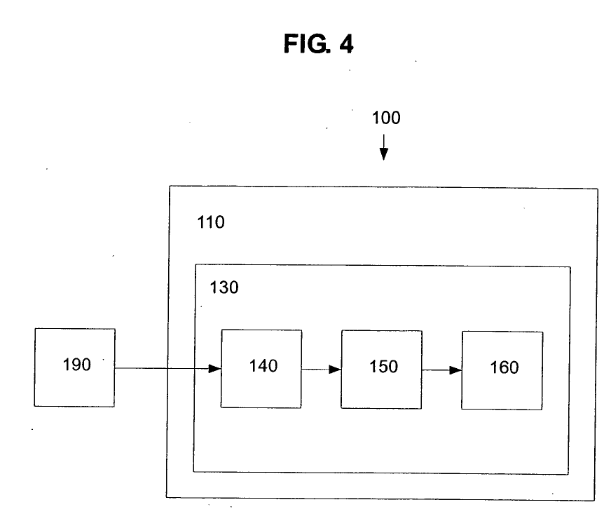

FIG. 4 shows a schematic presentation of the steps involved in the development of a tag relational database within an audio search system 100. As shown, the processor 110 comprises a query engine 130, a tagging application 140, a query engine search application 160, and a tag relational database 150. Additionally, an audio file 190 is shown. As indicated by arrows, in a first step, an audio file is received by the query engine 130. Next, a user assigns at least one tag to the audio file with the tagging application 140, or the computer algorithm assigns at least one tag to the audio file by statistical analysis of the audio characteristics. In some embodiments, the query engine 130 receives a plurality of audio files (e.g., at least 10, 50, 100, 1000, 10,000 audio files) and the query engine tagging application 140 assigns tags to each audio file. Finally, the tag relational database 150 provides consensus definitions of tags based upon statistical compilation of the characteristics of inputted audio files associated with a particular tag. In preferred embodiments, the tag relational database 150 permits the generation of audio file search requests based upon the consensus tag definitions.

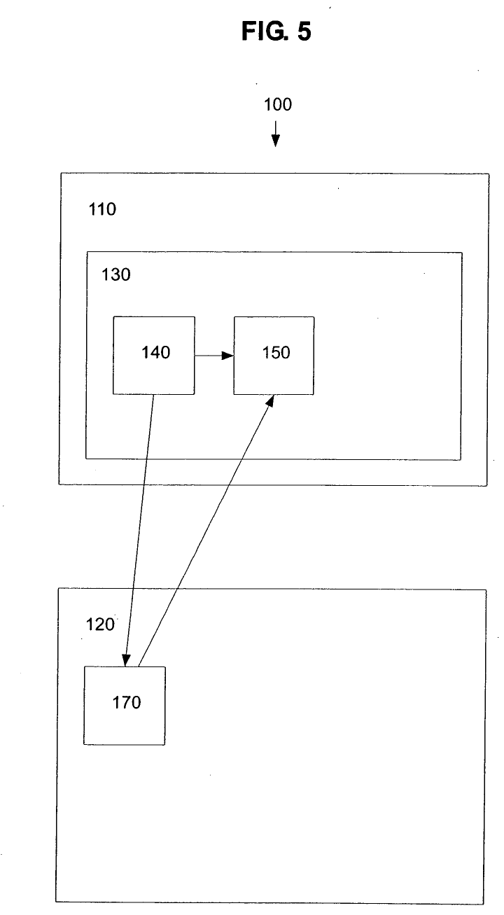

FIG. 5 shows a schematic presentation of the steps involved in an audio search request performed with the audio search system 100. As shown, the processor 110 comprises a query engine 130, a tagging application 140, and a tag relational database 150, and the digital memory 120 comprises a global tag database 170. First, an audio search request is generated with the query engine 130. In preferred embodiments, the audio search request is generated through identification of at least one tag from the audio segment(s) used for querying. As such, the audio search request comprises not only the elected tags, but the audio file characteristics associated with the tags (e.g., beat, performance title, tempo, etc.). Next, the audio search request is transmitted to the digital memory 120. Transmission of the audio search request may be accomplished by any manner, an internet based transmission is performed. Next, upon receipt of the audio search request by the query engine 130, the global tag database 170 identifies audio files matching the criteria (e.g., tags and associated audio file characteristics) of the audio file search request. Next, an audio file search request report is generated by the digital memory 120 and transmitted back to the processor 110. In preferred embodiments, the audio files identified in the audio file search request may be obtained (e.g., downloaded) from the digital memory to the processor 110. In other embodiments, a user of the audio search system 100 is directed (e.g., provided a link) to locations where the audio files identified in the audio file search request may be obtained (e.g., i-Tunes, Amazon). In this particular embodiment, a user is able to search for audio files (e.g., music files) that are consistent with the audio characteristics of the input audio file (e.g., tags and associated audio characteristics).

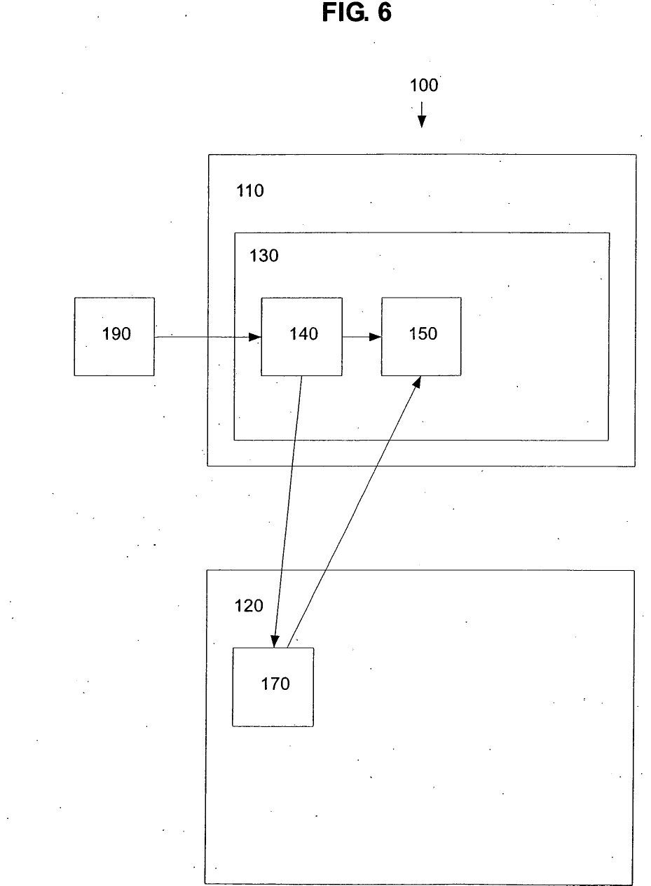

FIG. 6 shows a schematic presentation of the steps involved in an audio search request performed with the audio search system 100. As shown, the processor 110 comprises a query engine 130, a query engine tagging application 140, and a tag relational database 150, and the digital memory 120 comprises a global tag database 170. Additionally, an audio file 190 is shown. As shown in FIG. 6, an audio file 190 is received by the query engine 130, and a user assigns at least one tag to the audio file 190 with the query engine 130, or the query engine assigns at least one tag to the audio file by methods such as statistical analysis of the audio file's audio characteristics. In preferred embodiments, as described in more detail below, machine learning algorithms are utilized to analyze the digitized input audio file. This statistical analysis identifies audio characteristics of the audio file such as beat, tempo, key, etc., which are then defined by a tag. Optionally, a confidence value can be associated with the tag assignment to denote the certainty of the identification. Next, an audio search request is generated based upon the at least one tag assigned to the audio file 190. Next, the audio search request is transmitted to the digital memory 120. Transmission of the audio search request may be accomplished by any manner. In some embodiments, an internet based transmission is performed. Next, upon receipt of the audio search request by the query engine 130, the global tag database 170 identifies audio files matching the criteria (e.g., tags and associated audio file characteristics) of the audio file search request. Next, an audio file search request report is generated by the digital memory 120 and transmitted back to the processor 110. In some embodiments, within the audio file search request report audio files are given a confidence value denoting how certain the query engine believes the similarity between the received audio file and reported audio files. In preferred embodiments, the audio files identified in the audio file search request may be obtained (e.g., downloaded) from the digital memory to the processor 110. In other embodiments, a user of the audio search system 100 is directed (e.g., provided a link) to locations where the audio files identified in the audio file search request may be obtained (e.g., i-Tunes, Amazon). In this particular embodiment, a user is able to search for audio files (e.g., music files) that are consistent with the characteristics of a user-selected audio file.

Generally, the easy use of the audio search systems of the present invention in generating a tag relational database and performing audio searches represents a significant improvement over the prior art. In preferred embodiments, a tag relational database is generated in three steps. First, a user provides an audio file to the audio search system query engine. Audio files can be provided by “ripping” audio files from compact discs, or by providing access to an audio file on the user's computer. Second, the user labels the audio file with at least one tag. There are no limits as to how an audio file can be tagged. For example, a user can label an audio file with a subjectively descriptive title (e.g., happy, sad, groovy), a technically descriptive title (e.g., musical key, instrument used, beat structure), or any type of title (e.g., a number, a color, a name, etc.). Third, the user provides the tagged audio file to the tag relational database. The tag relational database is configured to analyze the audio file's inherent characteristics (e.g., instruments used, key, beat structure, tone, tempo, etc.) and associate the user provided tags with such tags. As a user repeats these steps for a plurality of audio files, a tag relational database is generated that can provide information about a particular tag based upon the characteristics associated with the audio files used in generating the tag. In preferred embodiments, the tag relational database is used in for generating audio search requests designed to locate audio files sharing the characteristics associated with a particular tag.

In some preferred embodiments, an audio search request is performed in four steps. First, a user creates an audio search request by supplying at least one audio file from a memory. The application creates at least one audio tag from the supplied audio file. The audio search request is not limited to maximum or minimum number of tags. Second, the audio search request is transmitted to a digital memory (e.g., external database). Typically, transmission of the audio search request occurs via the internet. Third, after receipt of the audio search request by the digital memory, the global tag database identifies audio files sharing the characteristics associated with the audio search request elected tags. Fourth, the digital memory creates an audio search request report listing the audio files identified in the audio search request.

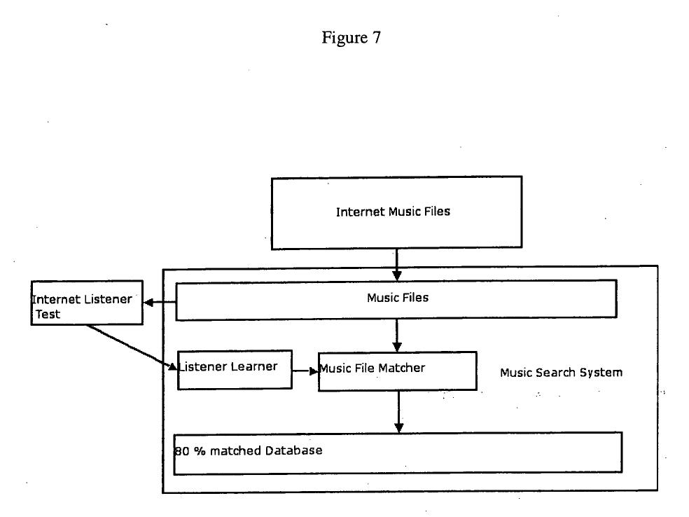

FIG. 7 depicts still further preferred embodiments of the present invention, and in particular, depicts the process for constructing a database of the present invention and the processes determining the relatedness of sound files. Referring to FIG. 7, a plurality of sound files (such as music or song files) are preferably stored in a database. The present invention is not limited to the particular type of database utilized. For example, the database may be a file system or relational database. The present invention is not limited by the size of the database. For example, the database may be relatively small, containing approximately 100 sound files, or may contain 10⁵, 10⁶, 10⁷, 10⁸ or more sound files. In some embodiments, music match scores are then gathered from a group of people. In preferred embodiments, a series of listening tests are conducted where individuals compare a sound file with a series of other sound files and identify the degree of similarity between the files. In further preferred embodiments, the individual's (or group of individuals) music match scores are learned using machine learning (statistics) and sound data so that the music match scores can be emulated by an algorithm. In preferred embodiments, the algorithms identify audio characteristics of an audio file and associate a tag with the audio file that corresponds to the audio characteristic. In some embodiments, the tag is an integer, or other form of data, that corresponds to a defined audio characteristic. In some embodiments, the integer is then associated with the audio file. In some embodiments, the data defining the tag is appended to an audio file (e.g., an mp3 file). In other embodiments, the data defining the tag is associated with the audio file in a relational database. In preferred embodiments, multiple tags representing discreet audio characteristics are associated with each audio file. Thus, the database is searchable by multiple criteria corresponding to multiple audio characteristics. A number of techniques, or combination of techniques, are preferably utilized for this step, include, but not limited, Decision Trees, K-means clustering, and Bayesian Networking. In some further embodiments, the steps of listening tests and machine learning of music match scores are repeated. In preferred embodiments of the present invention, these steps are repeated until approximately 80% of all songs added to the database match some song with a score of 6 or higher.

Still referring to FIG. 7, in order to build the audio search system of the present invention, a database is created. In preferred embodiments, the database is provided with audio files that are stored on the file system. In still further preferred embodiments, the listeners then compare one audio file in the database to a random sample of audio files in the database. In further preferred embodiments, a statistical learning process is then conducted to emulate the listener comparison. The last two steps (i.e., comparison by listeners and statistical learning) are repeated until 80% of the audio files in the database match some other audio file in the database.

In still further preferred embodiments, the database is accessible online and individuals (such as musical artists and users who purchase or listen to music) can submit audio files such as music files to the database over the internet. In some preferred embodiments of the present invention, listener tests are placed on the web server so that listeners can determine which audio files (e.g., songs) match with other audio files and which do not. In preferred embodiments, audio files are compared and given a score from 1 to 10 based on the degree of match, 1 being a very poor match and 10 being a very close match. In preferred embodiments, the statistical learning system (for example, a decision tree, K-means clustering, Bayesian network algorithm) generates functions to emulate the listener matches using audio data as the dependent variable.

In some embodiments of the present invention, the audio data begins as PCM (Pulse Code Modulation) data D, but may be transformed any number of times to generate functions to emulate the listener matches. Any number of functions can be applied to D. Possible functions include, but are not limited to, FFT (Fast Fourier Transform, MFCC (Mel frequency cepstral coefficients), and western musical scale transform.

In preferred embodiments, listener matches can be described as a conditional probability function P(X=n∥D), where X is the match score from 1 to 10, D the PCM data, is the dependent variable. In other words, given PCM data D, what are the chances that the listener would determine it matches with score n. The learning system emulates this function P(X=n∥D). It may transform D, for example by performing a FFT on D, to more easily emulate P(X=n∥D). More precisely, P(X=n∥D) can be transformed to P(X=n∥F( . . . F(D))). In some embodiments, the transformation data is used to determine if there is a statistical correlation to a tag by analyzing elements in the transformation to correspond to an audio characteristic such as beat, tempo, key, chord, etc. In preferred embodiments of the present invention, transformed data is stored on the relational database or within the audio file. In further preferred embodiments, the transformed data is correlated to a tag and the tag and the tag is associated with the audio file, for example, by adding data defining the tag to an audio file (e.g., an MP3 file or any of the other audio file described herein) or associated with the audio file in a relational database.

Musicologists have designed many transforms (frequency, scale, key) to analyze audio files. In preferred embodiments, applicable transforms are used to determine match scores. Many learning classification systems can be used to emulate P(X=n∥D). Decision tree, Bayesian network, Neural Network and K-means clustering to name a few. In some embodiments, new tests are created with new search audio files until the database can match a random group of audio files in the database to at least one search audio file 80% of the time. In preferred embodiments, if the database is created by selecting at random a portion of all the recorded CD songs, then when a search is made on the database with a random recorded song, 50, 60, 70 80, or 80 percent of the time a match will be found.

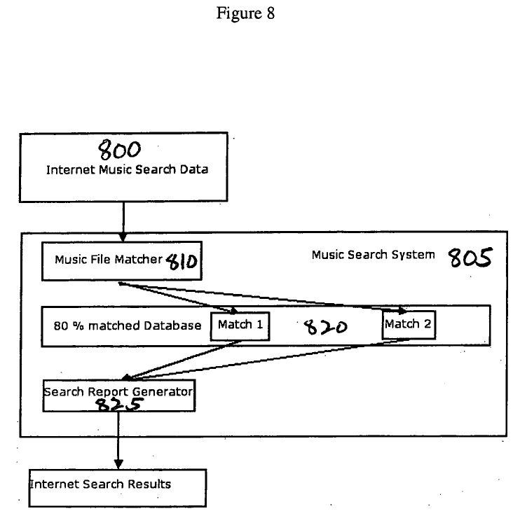

FIG. 8 provides a description of how the database constructed as described above is used. First, the audio data 800 from a user is supplied to the Music Search System 805. The present invention is not limited any particular format of audio data. For example, the sound data may be any type of format, including, but not limited to, PCM (Pulse Code Modulation, generally stored as a .wav (Windows) or .aiff(Mac-OS) file), Broadcast Wave Format (BWF, Broadcast Wave File), TTA (True Audio), FLAC (Free Lossless Audio Codec), MP3 (which uses the MPEG-1 audio layer 3 codec), Windows Media Audio, Vorbis, Advanced Audio Coding (AAC, used by iTunes), Dolby Digital (AC-3) or midi file. The sound data may be supplied (i.e., inputted) from any suitable source, including, but not limited to, a CD player, DVD player, hard drive, iPod, MP3 player, or the like. In preferred embodiments, the database resides on a server, such as a web server, and the sound is supplied via an internet or web page interface. However, in other embodiments, the database can reside on a hard drive, intranet server, digital storage device such a DVD, CD, flash card or flash memory or any other type of server, networked or non-networked. In some preferred embodiments, sound data is input via a workstation interface resident on the user's computer.

In preferred embodiments, music match scores are determined by supplying the audio data as an input or query audio file to the Music File Matcher comparison functions 810 as depicted in FIG. 8. The Music File Matcher comparison functions then compares the query audio file to database audio files contained in the Database 820. As described above, machine learning techniques are utilized to emulate matches identified by listeners so that the Music File Matcher functions are initially generated from listener test score data. In preferred embodiments, tags (which correspond to discreet audio characteristics) associated with the input audio file are compared with tags associated database audio files. In preferred embodiments, this step is implemented by a computer processor. Depending on how the database is configured, there is an approximately 50%, 60%, 70%, 80%, or 90% chance that the query sound file will match at least one database sound file from the Database 820. The Music File Matcher comparison function assigns database audio files contained in the Database 820 with a score correlated to the closeness of the database sound file to the query audio file. Database sound files are then sorted in descending order according the score assigned by the Music File Matcher comparison function. The scores can preferably be represented as real numbers, for example, from 1 to 10 or from 1 to 100, with 10 or 100 representing a very close match and 1 representing a very poor match. Of course, other systems of scoring and scoring output are within the scope of the present invention. In some preferred embodiments, a cut off value is employed so that only database sound files with a matching score of a predetermined value (e.g., 6, 7, 8, or 9) are identified.

In preferred embodiments, a Search Report Generator 825 then generates a search report that is communicated to the user via a computer interface such as an internet or web page or via the video monitor of a user's computer or work station. In preferred embodiments, the search report comprises a list of database sound files that match the query sound file. In preferred embodiments, the output included in the search report is a list of database audio files, with the most closely matched database audio files listed first. In some preferred embodiments, a hyperlink is provided so that the user can select the stored sound file and either listen to the sound file or store the sound files on a storage device. In other preferred embodiments, information on the sound file is provided to the user, including, but not limited to, information on the creator of the sound file such as the artist or musician, the name of the song, the length of the sound file, the number of bytes of the sound file, whether or not the sound file is available for download, whether the sound file is copyrighted, whether the sound file can be freely used, where the sound file can be purchased, the identity of commercial suppliers of the sound file, hyperlinks to suppliers of the sound file, other artists that make similar music to that contained in the sound file, hyperlinks to web pages associated with the artist who created the sound file such as myspace pages or other web pages, and combinations of the foregoing information.

The databases and search systems of the present invention have a variety of uses. In some embodiments, use defined radio programs are provided to a user. In these embodiments, a user searches a database of audio files that are searchable by multiple criteria and matching audio files in the database are provided to the user, for example, via streaming audio or a podcast. A streaming audio or podcast can be created using the same tools found in a typical audio search. First, the user inputs audio criteria to the radio program creator. The radio program creator searches with the user input for a song that sounds similar. The top search result is queued as the first song to play on the radio station. Next, the radio program creator searches with the last item in the queue as sound criteria. Again, the top search result is queued on the radio station. This process is repeated ad infinitum. The stringency of the search can be increased or decreased accordingly to provide a narrower or wider variety of audio files. In other embodiments, a sequence of songs to be played is selected by using an audio file to search a digitized database of audio files searchable by comparison to audio files with sound criteria.

In other embodiments, targeted advertising is related to sound criteria. In these embodiments, the user inputs sound criteria (i.e., a user sound clip) for comparison with audio files in a database. Advertising (e.g., pop-ups ads) are then provided to the user based on the user's inputted sound criteria. For example, if the inputted sound criteria contains sound qualities associated with hip-hop, preselected advertising is provided to the user from merchants selling products to a hip-hop audience.

In other embodiments, audio files are identified in a digitized database for use with advertising. In preferred embodiments, an advertiser searches for songs to associate with their advertisement. A search is conducted on the audio database using the advertiser's audio criteria. The resulting songs are associated with the advertiser's advertisement. In further embodiments, when a user plays a song in the audio database, the associated advertisement is played or shown before or after listening to a song.

In other embodiments, movies with desired audio characteristics are identified and selected by sound comparison with known audio files (e.g., sound clips) selecting at least one movie with related sound criteria. For example, the audio track from the movie is placed into the audio database. The database will contain only movie audio tracks. When a user searches with audio criteria, such as a car crash, only movies with car crashes will be returned in the results. The user will then be able to watch the movies with car crashes. In still further embodiments, movies are characterized by sound clips or the sound criteria that identify the movie. For example, the audio tracks from the movies are placed in the audio database. The audio database uses a frequency clustering method to cluster together like sounds. These clusters can then be displayed to the user. If a car crash sound is present in 150 different movies, each movie will be listed when the user views the car crash cluster.

In further embodiments, karaoke performances are scored by comparing prerecorded digitized audio files with live performance audio according to preset criteria. The song being sung is compared with the same song in the audio database. The karaoke performance is sampled in sound segments every n milliseconds (40 milliseconds provide good results on typical music). The frequencies used in the segment are compared with the prerecorded digitized sound segments. The comparison function returns a magnitude of closeness (a real number). All karaoke sound segments are compared with prerecorded digitized sound segments resulting in an average closeness magnitude.

In some embodiments, methods of creating a subset of audio files identified by user-defined sound criteria are provided. In still further embodiments, the results of queries to a database of audio files are analyzed. Desirable audio files are identified by compiling statistics on searches that are conducted to identify the most commonly searches audio files. In some embodiments, the musical preferences of an individual using the search systems and databases of the present invention are complied into a personal sound audio file containing multiple sound qualities. The preferences of individual users can then be compared so that users with similar preferences are identified. In other embodiments, users with similar musical preferences are associated into groups based on comparison of preferred sound criteria (i.e., the sound clips used by the individual to query the database) associated with individual users.

### EXPERIMENTAL

### Example 1

This example describes the use of the search engine of the instant invention to search for songs using thumbnails. Currently search engines such as Yahoo! and Google rely on alpha-numeric criteria to search alpha-numeric data. These alpha-numeric search engines have set a standard of expectation that when an individual conducts a search on a computer that the individual will obtain a result in a relatively prompt manner. The invented database of sounds and a search engine of sound criteria is expected to have a performance similar to the current alpha numeric search engines.

In this application an audio clustering approach is used to find similar sounds in a sound database based on a sound criteria used to search the sound database. This approach is statistical in nature. The song is broken down in to sound segments of a definite length, 40 milliseconds for example. The segments are compared with each other using a comparison function. The comparison function returns a magnitude of closeness (which can be a real number). Similarly sounding segments (large magnitudes of closeness) are clustered (grouped) together. Search inputs are compared to one segment in the cluster of sounds. Since all segments in the sound cluster are similar, only one comparison is needed to determine if all the sounds in the cluster are similar to the search input. This technique greatly improves performance. In the first experiment, the sounds were selected from digitized CD's although one can use any source of sounds. The first experimental group of sounds entered into the sound database were the songs: Bush—Little Things, Bush—Everything Zen, CCR—Bad Moon Rising, CCR—Down On The Corner, Everclear—Santa Monica and Iron Maiden—Aces High. The sounds varied in length from 31 seconds to 277 seconds. To enhance the time efficiency of the sound search, the sounds in the database were tagged with a serial cluster number. Each sound cluster is given a unique identifier, a serial cluster number, for identification and examination purposes.

Although in this experiment each song was only matched with one other song, each song can be decomposed into smaller and smaller sound segment criteria to allow better matching of sounds in the database to the sound criteria. If the audio clustering method finds a group of sounds that appear to be in more then one sound sources in the database this cluster of sounds becomes a criteria and can be used as a sound criteria by the sound search engine for finding similarities. To implement this invention computer software was used to tag the sounds of the sound criteria or thumbnail prior to searching the composed sound database. Sound clusters are saved in the search servers memory. Later, sound criteria are sent to the search server. The sound criteria are compared to the sound clusters. However, one could also tag the sound criteria or thumbnail without the use of computer by using mathematical algorithms that identify particular sound criteria in a group of sounds.

It is very beneficial to visualize perceived sounds. Users can come to expect future sounds and determine what something will sound like before they hear it. The current method maps perceived sound to a visual representation. Sound segments are represented visually by their frequency components. Some care must be taken when displaying frequency components. Psychoacoustic theory is used to exemplify only the frequencies that are perceived. Segments are placed in order to create a two dimensional graph of frequency over time. The music is played and indicators are placed on the graph to display what is currently playing. Users can look ahead on the graph to see what music they will perceive in the future.

The individual desiring to find sounds that match their sound criteria develops a sound thumbnail of digitized sounds. In this experiment, the sound thumbnail was a whole song, but could be increased to multiple songs. In this experiment, each thumbnail was composed of only a single sound but one can have a sound criteria composed of many sounds. The sound criteria or thumbnail used to search the composed sound database can be decomposed into smaller and smaller segments to allow better matching of the sound criteria to the sounds in the database. The length of the sound thumbnail should be a least long enough for a human to distinguish the sound quality.

Below is a summary of search data derived using the methods of the present invention. The sound criteria in the first experiment was the song Little Things by the artist Bush. When the sound database of the following songs was searched using the song Little Things as the sound criteria the song Little Things was found by the sound criteria search engine in 0.1 seconds, similar in performance to current alpha numeric search engines. The results are sorted by the average angle between audio vectors. cos(0 degrees)=1. The same song should have approximately 0 degrees between its audio vectors and the cosine of 0 degrees equals 1.

| | |
|---|---|
| Search Data | 3 Example Searches |

Search Song: Bush - Little things

| | | |
|---|---|---|
| 0 | 0.993318 | Bush - Little things |
| 1 | 0.833331 | Bush - Everything Zen |
| 2 | 0.802911 | Iron Maiden - Aces High |
| 3 | 0.802296 | CCR - Bad Moon Rising |
| 4 | 0.791322 | CCR - Down on the corner |
| 5 | 0.733251 | Everclear - Santa Monica |

Search Song: Bush - Everything Zen

| | | |
|---|---|---|
| 0 | 0.999665 | Bush - Everything Zen |
| 1 | 0.829756 | Bush - Little Things |
| 2 | 0.806475 | CCR - Bad Moon Rising |
| 3 | 0.798500 | Iron Maiden - Aces High |
| 4 | 0.790056 | CCR - Down On The Corner |
| 5 | 0.726827 | Everclear - Santa Monica |

Search Song: Iron Maiden - Aces High

| | | |
|---|---|---|
| 0 | 1.000000 | Iron Maiden - Aces High |
| 1 | 0.683768 | Bush - Little Things |
| 2 | 0.679466 | Bush - Everything Zen |
| 3 | 0.656596 | CCR - Bad Moon Rising |
| 4 | 0.632811 | CCR - Down On the Corner |
| 5 | 0.589817 | Everclear - Santa Monica |

### Example 2

This example describes the use of the methods and systems of the present invention to identify a database sound file matching a query sound file as compared to the same test done by individual listeners. The test method consisted of a search song, which is listed next to the test number, and candidate matches. Each candidate match was given a score from 1 (poor match) to 10 (very close match) by six participants. The participant score data were compiled and the six responses for each candidate song were averaged. The candidate songs were then arranged in descending order based on their average match score. The candidate song with the highest average score (Listener's top match) was assigned the rank of 1 and the candidate song with the lowest average score was assigned the rank of 8. The Music File Matcher was used to perform the same matching tests the same method was used to rank the candidate songs. The Listener's top match song was then found in the Music File Matcher list for each of the eight Tests, and the average Music File Matcher rank for the Listeners' top match songs was calculated. The average rank of the Listener top match songs within the Music File Matcher list was 2.875. For this set of Tests the rank error was 2.875−1=1.875. It is expected that as iterative rounds of listener ranking and machine learning are conducted, the rank error will approach zero

Test 1—Bukka White—Fixin'To Die Blues

### ABBA—Take A Chance On Me

### Albert King—Born Under a Bad Sign

### Alejandro Escovedo—Last to Know

### Aerosmith—Walk This Way

### Alice Cooper—School's Out

### Aretha Franklin—Respect

### Beach Boys—California Girls

### Beach Boys—Surfin' USA (Backing Track)

Listener's top match: Albert King—Born under a bad sign
Music File Matcher's rank of listener's top match: 3^{rd}

Test 2—Nirvana—In Bloom

### Beach Boys—Surfin' USA (Demo)

### Beastie Boys—Sabotage

### Beck—Loser.mp3

### Ben E. King—Stand By Me

### Billy Boy Arnold—I Ain't Got You

### Billy Joe Shaver—Georgia On A Fast Train

### Black Sabath—Paranoid

### BlackHawk—I'm Not Strong Enough To Say No

Test 5—CCR—Down on the corner

### Cowboy Junkies—Sweet Jane

### Cranberries—Linger

### Creedence Clearwater Revival—Bad Moon Rising

### Culture Club—Do You Really Want To Hurt Me

### David Bowie—Heroes

### David Lanz—Cristofori's Dream

### Def Leppard—Photograph

### Don Gibson—Oh Lonesome Me

Listener's top match: Creedence Clearwater Revival—Bad Moon Rising
Music File Matcher's rank of listener's top match: 1^{st}

Test 6—Butch Hancock—If You Were A Bluebird.mp3

### Donna Fargo—Happiest Girl In The Whole U.S.A

### Donovan—Catch The Wind

### Donovan—Hurdy Gurdy Man

### Donovan—Mellow Yellow

### Donovan—Season Of The Witch

### Donovan—Sunshine Superman

### Donovan—Wear Your Love Like Heaven

### Duke Ellington—Take the A Train

Listener's top match: Donovan—Catch The Wind
Music File Matcher's rank of listener's top match: 2^{nd}

Test 7—Cowboy Junkies—Blue Moon Revisited (Song For Elvis)

### Dwight Yoakam—A Thousand Miles From Nowhere

### Eagles—Take It Easy

### Elvis Costello—Oliver's Army

### Elvis Presley—Heartbreak Hotel

### Emmylou Harris—Wrecking Ball

### Elvis Presley—Jailhouse Rock

### Ernest Tubb—Walking The Floor Over You

Listener's top match: Beastie Boys—Sabotage
Music File Matcher's rank of listener's top match: 2^{nd}

Test 3—Chuck Berry—Mabeline

### Bo Diddley—Bo Diddley

### Bobby Blue Bland—Turn on Your Love Light

### Bruce Springsteen—Born to Run

### Bukka White—Fixin' To Die Blues

### Butch Hancock—If You Were A Bluebird

### Butch Hancock—West Texas Waltz

### Cab Calloway—Minnie The Moocher's Wedding Day

### Carlene Carter—Every Little Thing

Listener's top match: Bo Diddley—Bo Diddley
Music File Matcher's rank of listener's top match: 4^{th}

Test 4—Elvis Presley—Jailhouse Rock

### Carpenters—(They Long to Be) Close to You

### Cheap Trick—Dream Police

### Cheap Trick—I Want You To Want Me.mp3

### Cheap Trick—Surrender.mp3

### Chuck Berry—Johnny B. Goode

### Chuck Berry—Maybellene

### Chuck Berry—Rock And Roll Music.mp3

### Cowboy Junkies—Blue Moon Revisited (Song For Elvis)

Listener's top match: Chuck Berry—Johnny B. Goode
Music File Matcher's rank of listener's top match: 2^{nd}

### Ernest Tubb—Waltz Across Texas

Listener's top match: Emmylou Harris—Wrecking Ball
Music File Matcher's rank of listener's top match: 6^{th}

Test 8—Eagles—Take It Easy

### Fairfield Four—Dig A Little Deeper

### Fats Domino—Ain't That a Shame

### Fleetwood Mac—Don't Stop

### Fleetwood Mac—Dreams

### Fleetwood Mac—Go Your Own Way

### Nirvana—In Bloom

### Cranberries—Linger

### Beck—Loser.mp3

Listener's top match: Fleetwood Mac—Go Your Own Way
Music File Matcher's rank of listener's top match: 3^{rd}

All publications and patents mentioned in the above specification are herein incorporated by reference. Although the invention has been described in connection with specific preferred embodiments, it should be understood that the invention as claimed should not be unduly limited to such specific embodiments. Indeed, various modifications of the described modes for carrying out the invention that are obvious to those skilled in the relevant fields are intended to be within the scope of the following claims.

We claim:

1. A method of providing a user with a user defined radio program comprising providing a digitized database of audio files searchable by comparison to audio files with multiple criteria.

2. A method comprising relating advertising to sound criteria.

3. A method of finding advertising audio files from a digitized database of audio files searchable by comparison to audio criteria.

4. A method comprising selecting a sequence of songs to be played by searching using an audio file and a digitized database of audio files searchable by comparison to audio files with criteria.

5. A method comprising identifying an audio file by associating said audio file with at least three common sound qualities to create a sound thumbnail.

6. A method comprising identifying movies by sound comparison with known audio files selecting at least one movie with related sound criteria.

7. A method comprising characterizing movies by sound criteria.

8. A method comprising scoring karaoke performances by comparing prerecorded digitized audio files with live performance audio according to preset criteria.

9. A method comprising creating a subset of audio files identified by user-defined sound criteria.

10. A method comprising associating musical preferences of a human individual by comparing said human individual's personal sound audio file with other human individual's preferred audio file.

11. A method comprising identifying desirable audio files by the results of multiple audio file queries.

12. A method comprising associating users with similar musical preference by associating preferred criteria with said user and using said preferred criteria to associate groups of users.

13. A method comprising creating a subset of audio files identified by a sound thumbnail.

14. A method comprising creating a subset of audio files identified by sound thumbnails.

15. A method comprising displaying music visually as it is playing.
